(19) United States
(12) Patent Application Publication
(10) Pub. No.: US 2003/0174651 A1
(43) Pub. Date: Sep. 18, 2003

(54) Control method and system composed of outer-loop steady-state controls and inner-loop feedback controls for networks

(76) Inventor: Blaise Morton, Huntington Station, NY (US)

Correspondence Address: Blaise Morton, 15345 Woodside Lake, Minnetonka, MN, 55345, US

(21) Appl. No.: 10/383,806

(22) Filed: Mar. 8, 2003

Related U.S. Application Data
(60) Provisional application No. 60/364,408, filed on Mar. 13, 2002.

(51) Int. Cl. H04L 12/26

(52) U.S. Cl. 370/235

(57) ABSTRACT

A control method and system is defined for routing messages from source nodes to destination nodes of a network. An outer-loop control subsystem computes a desired steady-state routing solution in response to an estimated input data rate and an estimated output data rate. An inner-loop control subsystem reduces the deviations of estimated queuing lengths from expected queuing lengths at each node by adjustment of the routing solution.

### CROSS-REFERENCE TO RELATED APPLICATION

This application claims priority from U.S. Provisional Application No. 60/364,408 filed on Mar. 13, 2002 for inventor Blaise Morton and entitled A SYSTEM OF NETWORK CONTROLS COMPOSED OF OUTER-LOOP STEADY-STATE BOUNDARY CONTROL AND INNER-LOOP FEEDBACK CO-BOUNDARY CONTROL.

### TECHNICAL FIELD

The present invention relates to control of network systems, for example, communications systems, computer systems, command and control systems. In particular, the present invention relates to a control system and method that maintains network operation in a range of specified performance and adopts a routing methodology to compensate fluctuations of data packet inputs and uncertainties of network operations.

### BACKGROUND

FIG. 1 shows a graphical model of a typical network structure for, for example, communications systems, computer systems, command and control systems. Within the networks messages are communicated, where a message is a unit passed on links between a pair of nodes. Depending on different practices, a message may also be called a cell, a frame, a packet, or a data block, etc. Each node (10) of the graph represents a set of receivers, buffers, processors and transmitters, which are working together as a unit for receiving messages, identifying their destinations, and sending them to other nodes. Each link (12) of the graph represents a communication channel of some sort, for example, wire, fiber optic cable, wireless link, by which messages may pass from one node to another. For any pair of nodes in the graph, the lack of a link between them means that messages may not pass directly between those two nodes, while the presence of a link indicates that messages may pass between them.

Referring to FIG. 2, for a string of messages, a node where the message enters into the network is its source node (shown as (42) or (40)) and a node where the message leaves from the network is its destination node (shown as (44)). The string takes a route (a sequence of links via a sequence of nodes) from its source node to its destination node. A node that is neither a source node nor a destination node of the message may or may not play a role of router if the message goes through the node (shown as (46)).

Different requirements, for example, latency of delivering a message, data rates, and message blocking rates from entering into the network, etc., may apply to different types of networks for achieving different objectives. For example, referring to FIG. 3, a network could be an administrative domain operated by a carrier or an operator that receives messages from other domains of the Internet in order to serve user's voice, web-browser, or multimedia services. A network may be a computer network system where messages are exchanged between different stations in order to accomplish jobs. A network may also be applied to a control or command system composed of multiple servers, where the servers exchange information between each other in order to cooperatively control a client system. These types of networks are abstracted into the mentioned graph model for the sake of explanation of the present invention.

There are several types of controls for networks. First, admission control determines admission or rejection of messages entering into the network. Second, routing determines the route of a message from its source node via a sequence of intermediate nodes to its destination node through a network. Third, prioritization of messages accessing a shared link enables different latency requirements to be achieved for different type of messages. Fourth, dropping of messages at the buffer of a node, if possible, assists the transmission of other types of messages of more significance.

No matter what types of controls are implemented, it is highly desirable to maintain network operations near steady states that do not exceed the hardware and software limitations. It is furthermore desirable to control the operations within a specific range of states because the range reflects the requirements on hardware and software sizes. The larger the allowed operating range, the more expensive the hardware and software may be.

There are many challenges for networks control, for example, unpredictable data inputs causing congestion at nodes, uncertainties of network operation such as link failures, distributed network topology adding difficulties (therefore, the routing method plays an important role in network control), etc. The challenges and shortcomings of the current practices will be discussed to show the need for an improved network control methodology and an improved routing method.

Current practices of routing messages in a network can be generally categorized in three categories: circuit switched networks, virtual circuit-switched networks and packet switched networks. They are explained in the following paragraphs.

In a circuit-switched network, a fixed path of links with dedicated resource is allocated, when the session for the transmission is originated, to a string of message transmission between its source node and its destination node. Usually the resource of the path remains dedicated to the session until it ends. No other messages may use the same links dedicated to the session while it is active, even if no messages from the session are being sent. The plain old telephone system still in used today is based on this type of routing. It is not an efficient use of resources, so more efficient methods have been developed for routing in applications such as multi-user data and image transmission networks.

In a virtual-circuit routing strategy, the path with resource allocation for a session from its source node to its destination node is also established when the session for the transmission is originated. A pipeline dedicated to the message is reserved for its transport. Once the message enters the network, the set of links from its source node to its destination node should be available when needed and no algorithm choices regarding the path are made en route. The resources for the session on the dedicated path are free when no messages from the session are being sent and can be used by other sessions. Therefore, the virtual-circuit methodology may be more efficient than the circuit-switched methodology.

In a packet-switched network, a message enters the network without a pre-defined path to its destination node. The packets are tagged with their final destinations, but the decision regarding the path followed is made at each node along the way. This approach removes the inefficiency of circuit switching and is simpler than virtual-circuit switching because it does not require the advance scheduling of paths. One disadvantage of packet switching is that messages often have to wait at nodes because other messages that arrived earlier are being served ahead of them. Another disadvantage arises because there are no pre-planned paths for sessions, so packets often encounter local congestion, implying transmission latency of messages without a guaranteed bound on the size of delay.

For circuit-switched and virtual circuit-switched applications, switch tables with respect to each individual session are used, in which each session is switched individually to the next link. The switch table is decided when a session is originated. For packet-switched applications, routing tables are used to route messages based on their destination nodes. Messages of a session may flow along different routes if routing tables are updated during transmission of the session.

While methods currently employed for determining the routing of messages in packet-switched networks are varied, the following features are typical. First, the link selected for a message leaving a node is determined by a table look-up function. Second, the lookup table is updated by the node when it receives information about changes in the network topology. Third, each node performs the update based on shortest-path types of algorithm, depending on the final destination of the message and the node's internal model of network topology.

The current methodology for routing messages in a packet-switched network has some shortcomings that need be addressed. One of the shortcomings is that the shortest path is often not the most efficient path to transport a message from source to destination. Referring to FIG. 4, the shortest-path to transport a message from source node a₁ to destination node a₂ is through links (26) and (28). Assume node a₄ is congested with packets while nodes a₇ and a₆ have excess capacity. Directing some load from the path of links (26) and (28) to the path of links (30), (32) and (34) would be more efficient, even though the later is not the shortest path from source node a₁ to destination node a₂. The physical properties of network elements, such as transmitters, links, receivers, buffers and processors, impose limitation on the achievable nominal performance of the network. This increases the change of traffic congestion along the shortest-path. Also, some network elements may unpredictably fail, either partially or completely, either permanently or temporarily, in what is called an upset event. In case of an upset event, it is desirable that the routing method be able to adjust for the change to the network and keep the performance of the system within acceptable ranges, if possible. Since the shortest-path algorithm is not able to accommodate the traffic congestion en route, it does not utilize the network resources efficiently.

What is needed is a network control system and a method to route messages through a network that is capable of accommodating network topology, traffic pattern, and physical properties in order to drive network operation within a range of specified performance requirement.

### SUMMARY

The present invention is a control method for network systems, for example, communications systems, computer systems, command and control systems. The objective is to drive networks to operate within a range of specified performance by an outer-loop control subsystem and an inner-loop control subsystem.

In the outer-loop control subsystem, control strategies are chosen to enable the network to operate near desired steady states and to meet required network performance. Steady-state routing flow rates on links are computed based on message input rates to the networks and their destination nodes. In the inner-loop control system, adjustments of the network strategies are computed to compensate fluctuations of message inputs and uncertainties of network operation. Adjustments of routing flow rates are computed so that the network will not deviate too far from desired steady states.

### BRIEF DESCRIPTION OF THE DRAWINGS

The present disclosure will be more clearly understood after reference to the following detailed specification is read in conjunction with the drawings, wherein:

FIG. 1 illustrates a graphical model of a network;

FIG. 2 illustrates the composition of a network, where for a string of message, a node may be a source node, a destination node or a router;

FIG. 3 illustrates how one administrative domain relates to other administrative domains of the Internet;

FIG. 4 is a graphical model of a network showing how the conventional shortest path routing model works;

FIG. 5 illustrates a preferred method for an embodiment of a network control system composed of an outer-loop control subsystem and an inner-loop control subsystem;

FIG. 6 illustrates an example of cycles within a network;

FIG. 7 illustrates a preferred method for an embodiment of the inner-loop control subsystem using dynamic routing; and

FIG. 8 is a functional block diagram showing one embodiment of the network control system according to the present invention.

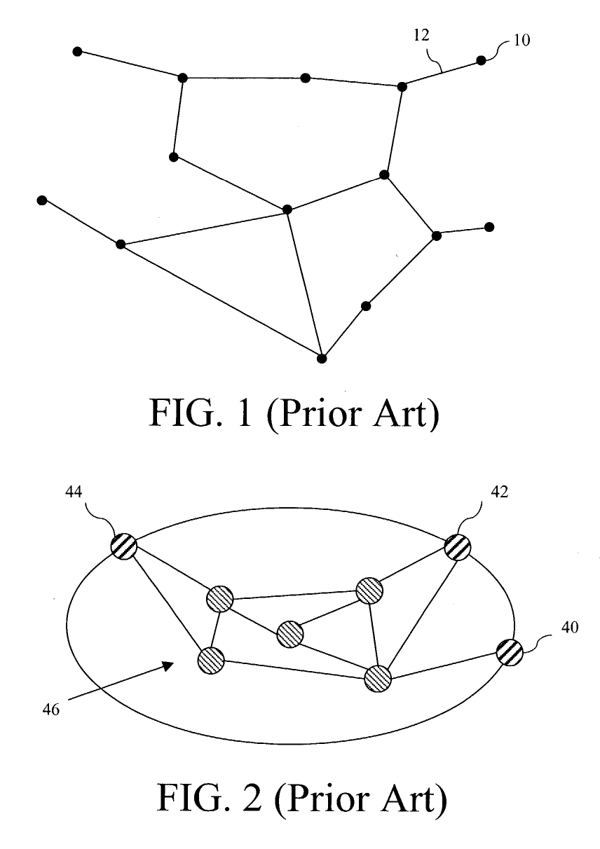

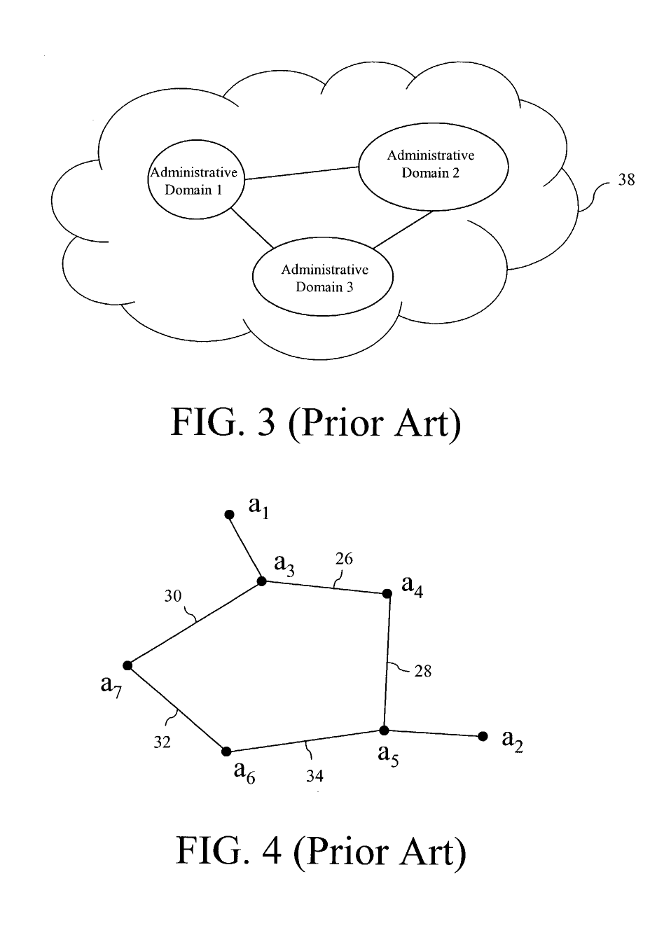

### DESCRIPTION OF THE PREFERRED EMBODIMENTS

The preferred embodiments of the present invention will be described with references to the figures wherein like numerals represent like elements throughout.

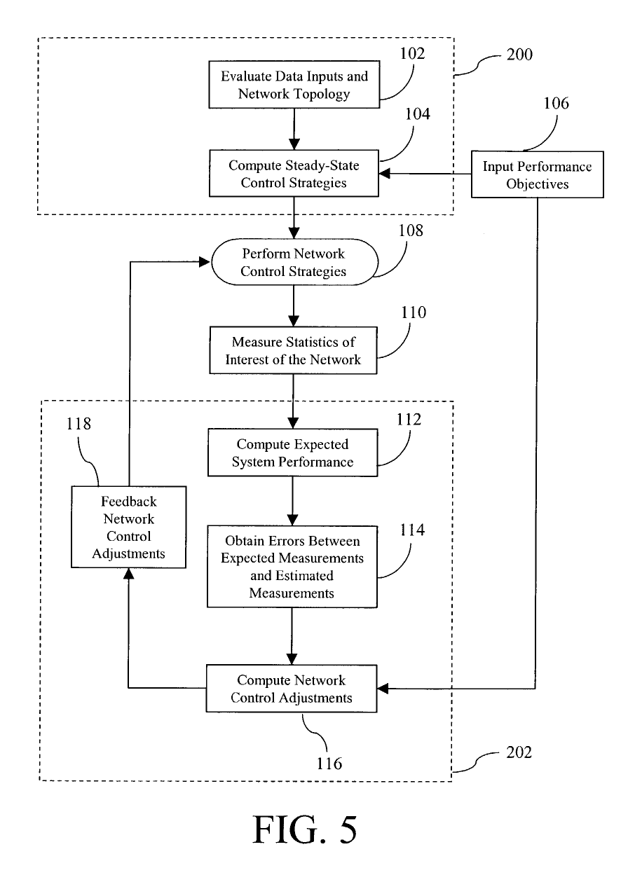

Referring to FIG. 5, a method for an embodiment of the control system according to the present invention is shown. Statistics of interest, e.g., data input rate of each string of messages, network performance and the overall network topology are evaluated at step (102). A steady-state control strategy is computed at step (104) based on the performance objectives from step (106) and the evaluation of step (102). The control strategy is designed to maintain network operations near steady states and optimize the network performance. Steps (102) and (104) can be performed by one or a plurality of processors that are implemented either in a centralized way or in a distributed way, where control information will be exchanged between network nodes to achieve the purpose cooperatively. The loop composed of steps (102), (104) is denoted as an outer-loop control subsystem (200) of the method presented in the embodiment. The control subsystem may, at any time, update control parameters in order to accommodate updated message input rates and network topology changes.

The control strategy comprises many types of network control methodologies. First, an admission control mechanism may completely or partially reject messages from entering into the network in order to manage message input rates. Second, a routing strategy may determine to which node a message should be forwarded such that the message will eventually arrive its destination node and also meet the control objective. Third, drops of some or all packets at some nodes may also be used. It should be understood by those skilled in the art that the network control may comprise one or several of the above different types of control methods, and may also comprise other types of control methods of networks.

The objective of the control strategy in step (104) is primarily to ensure network operation near steady states, and secondly, to meet or optimize the performance objective of step (106). A simple way to determine whether or not the network is in a steady state, for given routing flow rates, is to see whether for each node the message input rate is the same as the message output rate. Another criterion is to ensure, for each type of message, that the input rates into the network from outside is the same as the output rate from the network.

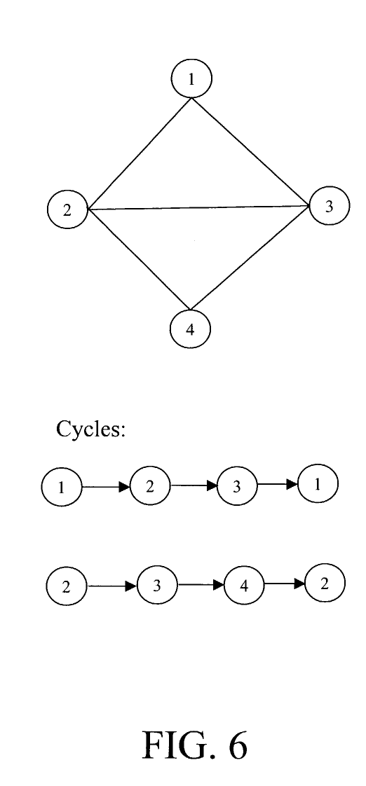

It is easy to examine steady-state routing flow rates, but it is usually hard to optimize routing flow rates because it is not obvious how to describe all possible steady-state routing flow rates on networks. One method to obtain the set of steady-state routing flow rates is first to pick an arbitrary set of directional steady-state routing flow rates on links, say Rₒ, which is a directional description of flow rates—if the flow rate from node a to node b is f (a real number), then either f on link (a, b) or—of on link (b, a) describe the same physical flow rate. The set of steady-state routing flow rates, denoted by R(C), is parameterized by

$$R ( C ) = {R}_{0} + {\sum }_{j = 1}^{L} {c}_{j} {z}_{j} \qquad ( Equation 1 )$$

where Z is the space of directional cycles (where packets flow from one node to several other nodes and then back to the original node; detailed explanation of cycles will be described later), where L is the number of links minus the number of nodes and then plus 1, and L is the dimension of the cycle space Z, zⱼ is a basis of Z, and C is an R×L real matrix whose j-th column is cⱼ. To explain the cycle space Z, referring to FIG. 6, there are four nodes, node 1, node 2, node 3, and node 4. For example, A messages flow rate x from node 1, to node 2, to node 3, and then to node 1, is a cycle, which is the same as saying a message flow rate x from node 1, to node 3, to node 2, and then to node 1. Similarly, a certain amount of messages flow from node 2, to node 3, to node 4, and then to node 2, is also a cycle. The dimension L of this network is 2. In other words, for an arbitrary steady-state routing flow rate Rₒ, any other steady-state routing strategy with the same input rates and output rates can be obtained by adding one or more directional cycles to Rₒ. The set of steady-state routing flow rates is a L-dimension linear space as described in (Equation 1). This method is useful for optimization of a cost function (corresponding a performance objective) because the set of routing policies is parameterized. Once a steady-state (directional) routing flow rate is obtained, the physical flow rates on links can easily be obtained by reversing the direction of flows of negative entries on links.

Other methods may be used to ensure the steady-state objective and it should be understood that the method in the previous discussion is used as an example. It can be seen that there may be multiple routing flow rates that will produce network steady state if the network contains cycles. The present invention chooses one or a set of control strategies based on performance objectives, for example, to minimize the transmission latency from a source node to a destination node or to minimize the probability of network congestion, etc. Different steady-state routing flow rates may be chosen for different performance requirements. One way to choose appropriate control strategies is by optimizing a cost function, which represents the performance requirement, over the set R(C) in (Equation 1). It should be understood by those of skill in the art that many different factors may affect the performance objective and the method to choose control strategies, for example, hardware and software limitation, quality-of-service requirements and/or economic objectives. This invention should not be limited to any specific performance objective.

At step (108), the network control strategies chosen in step (104) are performed with feedback of control adjustments from step (118), which may be of one or multiple types of control, for example, admission control and/or routing control, etc.

The inner-loop control subsystem (202), composed of steps (112), (114), (116) and (118), is to compensate fluctuations of message inputs and/or other sources of uncertainties of network operation while still maintaining network operation near steady state. This inner-loop control subsystem (202) may operate at the same or different time scales from that of the outer-loop control subsystem (200). Statistics of interest of the network, for example, amount of data queuing at nodes, delay of data transmissions, or bandwidth utilization of links, etc., are measured at step (110). Step (114) is to obtain the differences of the measurements obtained in step (110) from the expected measurements of the network operating under the selected steady-state control strategies by step (112). The differences will be used for obtaining a control adjustment for compensating message flow-rate deviations from those of the selected steady states at step (116). Once an adjustment of network control is obtained, at step (118) the control adjustment is fed back to step (108). The network control strategies at step (108) updated by the network control adjustment then drive the network operation toward a desired steady state.

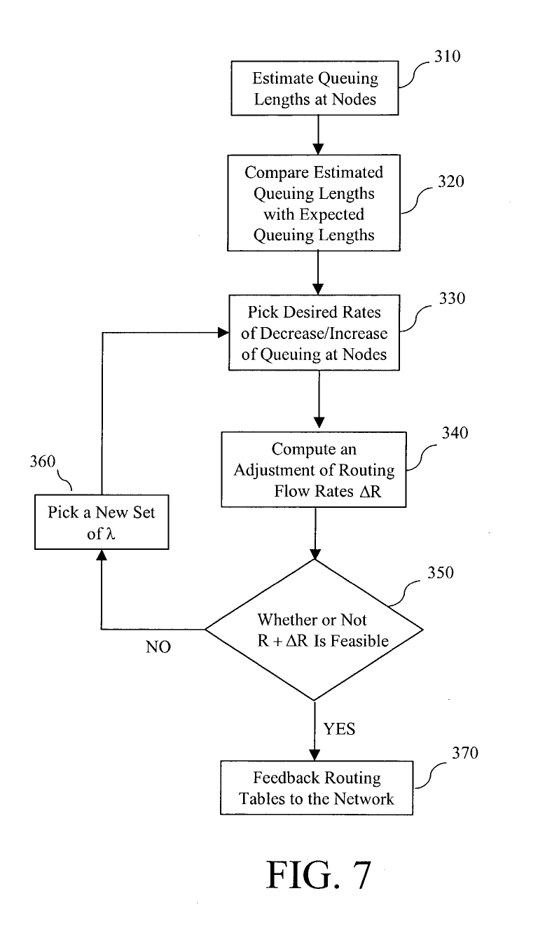

Referring to FIG. 7, one preferred method implementing the inner-loop control subsystem of FIG. 5 is to use dynamic routing in order to load balance among nodes with large message queues and those with small or no messages queues. The queuing lengths, say Q(i), at each node, where i indicates the i-th node, are estimated at step (310). The estimated queuing lengths Q(i) are compared with the expected queuing lengths E(Q(i)) of the outer-loop control subsystem (200) of FIG. 5 at step (320). At step (330), desired rates of increase or decrease at each node for load balance among queues are computed by the following steps. First, pick some λᵢ≧0 such that

$${\sum }_{i = 1}^{N} {λ}_{i} ( E ( Q ( i ) ) - Q ( i ) ) = 0 , \qquad ( Equation 2 )$$

and, second, let G be a N-dimensional vector with

G(i)=λᵢ(E(Q(i))−Q(i)). (Equation 3)

An adjustment of flow rates on links are obtained at step (340) by computing

ΔR=δ(A(G)), (Equation 4)

where δ is the mathematical co-boundary operator, and A is an operator on the set

$$K = \{ x ∈ {R}^{N} : x = ( {x}_{1} , … , {x}_{N} ) , {\sum }_{i = 1}^{N} {x}_{i} = 0 \} ,$$

such that

∂∘δ∘A=Identity: K→K, (Equation 5)

where ∂ is the mathematical boundary operator.

Once an adjustment of flow rates, ΔR, on links is chosen at step (340), the vector of desired flow rates on links are R+ΔR, (where R is the vector of desired steady-state routing flow rates obtained in the outer-loop control subsystem (200) of FIG. 5). It is to be determined in step (350) whether or not R+ΔR is associated with feasible routing rates on links, subject to the bandwidth on links and other feasibility constraints. If R+ΔR is feasible, then routing tables at nodes are generated corresponding to R+ΔR at step (370) and the routing tables are fed back to step (108) of FIG. 5. If R+ΔR is not feasible, then pick a different set of λi≧0 at step (360), and compute a new adjustment of flow rates ΔR. Notice that there will be a set of λi≧0 for a feasible flow rates because we can simply put λi=0 at every node (which means no flow-rate adjustment).

The procedure described in the method of FIG. 7 is an embodiment of the inner-loop control subsystem denoted in (202) in FIG. 5. As is understood by a person skilled in the art, adjustments used in network control can be of different types, for examples, dynamic routing where the routing strategy obtained in (200) of FIG. 5 is adjusted, or dropping of packets at nodes when necessary, etc.

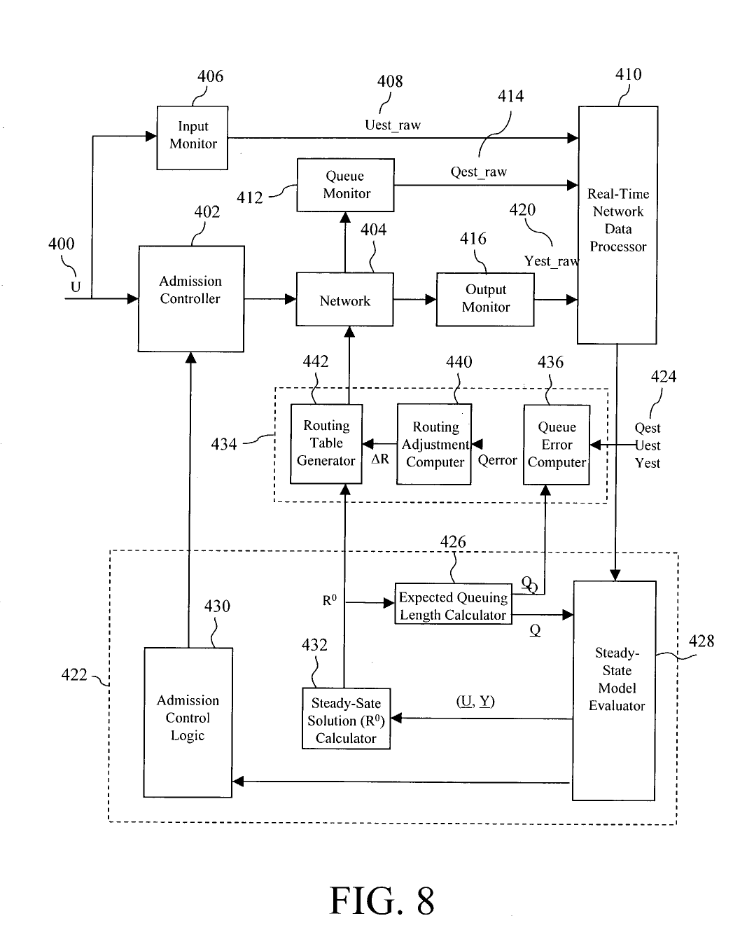

FIG. 8 is a functional diagram of a control system implementing the methods disclosed in FIG. 5 and FIG. 7, according to one preferred embodiment of the present invention. The message inputs, denoted by U (400), to the Network (404) are controlled by Admission Controller (402), which decides whether to admit or reject the messages. Messages admitted by Admission Controller (402) are sent to the Network (404), which is the entity to be controlled.

Statistics of several types of information including inputs, outputs and queues at network nodes are to be collected. Input Monitor (406) monitors information of message inputs that may include, but are not limited to, message sizes, message identification number, or time of entry into the network, etc. The raw data of message inputs for estimation, denoted by Uₑₛₜ_{_{—}}_{raw} (408), are sent to Real-Time Network Data Processor (410), which estimates information of the system. Queue Monitor (412) sends the raw data of amount of queues at nodes, denoted by Qₑₛₜ_{_{—}}_{raw} (414), to (410). Similarly, Output Monitor (416) sends the raw data of information of outputs, denoted by Yₑₛₜ_{_{—}}_{raw} (420), sent to (410). It is noted that Input Monitor (406), Queue Monitor (412), and Output Monitor (416) could be implemented as one or multiple processors.

The Outer-Loop Control Subsystem (422) comprises the following elements. The estimation of inputs, queues and outputs (424), denoted by Uₑₛₜ, Qₑₛₜ and Yₑₛₜ respectively and the expected queuing lengths at nodes, denoted by Q, computed by the Expected Queuing Length Calculator (426), are sent to the Steady-State Model Evaluator (428), which evaluates whether or not the Network (404) is close to a steady state. One way to determine network steady states is mentioned previously in the method of FIG. 5. If the network cannot operate near steady states, because of hardware or software limitation, etc., the Steady-State Model Evaluator (428) sends a message that may include the number of messages to be rejected or admitted to the Admission Control Logic (430) for execution of the admission control by (402). Alternatively, if the queuing at nodes is too long, the Steady-State Model Evaluator (428) may also signal Admission Control Logic (430) for execution of admission control. Meanwhile, the steady-state message input rates, denoted by U, and steady-state message output rates, denoted by Y, are sent to the Steady-State Solution (R°) Calculator (432) that will compute the steady-state routing flow rates (R°) based on U and Y. The above procedures and elements complete the Outer-Loop Control Subsystem (422).

The Inner-Loop Control Subsystem (434) comprises the following elements. The Queue Error Computer (436) computes the difference, denoted by queuing error values Qₑᵣᵣₒᵣ, between the estimated queuing lengths Qₑₛₜ from (410) and the expected queuing lengths Q from (426) for each node. The Routing Adjustment Computer (440) computes an adjustment of routing flow rates ΔR based on the queuing error values Qₑᵣᵣₒᵣ and sends it to the Routing Table Generator (442), which generates routing tables for each node based on R°+ΔR, and the routing tables are sent to the Network (404). A method for computing ΔR is mentioned previously in FIG. 7. The above procedure completes the Inner-Loop Control Subsystem (434).

The preferred embodiments and examples are merely illustrative of the present invention rather than limits to the present embodiment. As is understood by a person skilled in the art, the foregoing preferred embodiments and examples are merely illustrative of the present invention rather than limits to the present disclosure. This disclosure is intended to cover various modifications and similar arrangements included within the spirit and scope of the appended claims, the scope of which should be accorded the broadest interpretation so as to encompass all such modifications and similar structures.

What is claimed is:

1. A control system for communications networks, comprising:
a network providing communication paths for delivery of messages from a source node to a destination node;
an outer-loop control subsystem for generating a desired steady-state routing solution consistent with expected input rates and output rates; and
an inner-loop control subsystem that adjusts the routing solution to reduce deviations of estimated queuing lengths from expected queuing lengths.

2. The control system of claim 1, further comprising an admission control mechanism responding to an admission command generated by the outer-loop control subsystem, wherein the admission control mechanism selectively rejects data packets from entering into the network for managing input rates of data packets.

3. The control system of claim 1, further comprising an input monitor monitoring input data packets from outside of the control system for generating raw data of input packets with different destination nodes, wherein the raw data of input packets includes, but not limited to, message sizes, message identification numbers, and time of entry into the network.

4. The control system of claim 3, further comprising an output monitor monitoring output data packets from the network for generating raw data of output packets at each destination node.

5. The control system of claim 4, further comprising a queue monitor monitoring the amount of queuing data at each node for generation of raw queuing data.

6. The control system of claim 5, further comprising a real-time network data filter that takes as inputs the raw data of input packets at source nodes, the raw data of output packets at destination nodes, and the raw queuing data at each node to provide estimated input data rates, estimated output data rates, and the estimated queuing lengths.

7. The control system of claim 6, wherein the outer-loop control subsystem comprises a steady-state network model evaluator responding to the estimated input data rate, the estimated output data rate, and the estimated queuing lengths at nodes for generation of an expected steady-state input data rate and an expected steady-state output data rate or other statistical parameters of the network including, but not limited to, the expected value of a performance cost function.

8. The control system of claim 7, wherein the outer-loop control subsystem comprises a steady-state solution calculator responding to the expected steady-sate input data rate and the expected steady-state output data rate for generation of the desired steady-state routing solution.

9. The control system of claim 8, wherein the outer-loop control subsystem comprises an expected queuing length calculator responding to the desired routing solution for generation of the expected queuing lengths at nodes.

10. The control system of claim 9, wherein the inner-loop control subsystem generates queuing error values as the differences between the estimated queuing lengths and the expected queuing lengths at nodes.

11. The control system of claim 10, wherein the inner-loop control subsystem generates the adjustments to the routing solution based on the queuing error values at nodes.

12. The control system of claim 11, wherein the inner-loop control subsystem comprises a routing table generator for providing a routing table that is responsive to the desired steady-state routing solution and the adjustments of the routing solution to compensate queuing lengths at network nodes.

13. A method for routing messages from source nodes to destination nodes through a network, the method comprising:
monitoring the network to produce an estimated input data rate and an estimated output data rate;
computing a steady-state routing solution based on the estimated input data rate and the estimated output data rate;
producing a corrective routing adjustment based on amounts of queuing data at nodes of the network; and
determining and updating routing tables at each node based on the steady-state routing solution adjusted by the corrective routing adjustment, wherein each node routes a packet based on the routing table of the node.

14. The method of claim 13, wherein the step of producing a corrective routing adjustment further comprises:
determining estimated queuing lengths reflecting raw amounts of queuing data at nodes;
determining expected queuing lengths at nodes based on the steady-state routing solution;
monitoring the network to generate estimated queuing lengths at nodes;
computing the queuing error values of nodes as the differences of the expected queuing length from the estimated queuing length; and
producing the corrective routing adjustment based on the queuing error values.

15. The method of claim 13, wherein the steady-state routing solution is determined according to a desired cost function comprising an objective of maximum message flow rates, or of minimum cost of delivery of message packets through the network subject to specified performance constraints.

16. The method of claim 13, further comprising a step of controlling admission of input message packets to the network based on amounts of queuing data at network nodes.

17. A method for controlling flows through a network, the method comprising:
determining a vector of network flow rates on network links based on estimated input data rates at source nodes and estimated output data rates at destination nodes for operating the network flows consistent with a steady state, wherein the vector of network flow rates is selected from a set of vectors of network flow rates that are parameterized by the space of network cycles;
adjusting the network flows rates on networks links for driving the network flow rates toward a steady state and for balancing queuing lengths among network nodes.

18. The method of claim 17, wherein the step of adjusting the network flow rates on links comprises an objective not to change the total estimated amount of data in the network system.
